(19) United States
(12) Patent Application Publication
(10) Pub. No.: US 2026/0016227 A1
(43) Pub. Date: Jan. 15, 2026

(54) INDUCTION HEATING DEVICE FOR METAL PLATE, PROCESSING EQUIPMENT FOR METAL PLATE, AND INDUCTION HEATING METHOD OF METAL PLATE

(71) Applicant: NIPPON STEEL CORPORATION, Chiyoda-ku, Tokyo (JP)

(72) Inventor: Yoshiaki HIROTA, Chiyoda-ku, Tokyo (JP)

(21) Appl. No.: 18/995,162

(22) PCT Filed: Jul. 29, 2022
(86) PCT No.: PCT/JP2022/029400

§ 371 Date: Jan. 16, 2025

(51) Int. Cl. F27B 9/06; B21B 1/22; B21B 1/28; B21B 45/00; F27D 11/06

(52) U.S. Cl. CPC F27B 9/067; B21B 1/28; B21B 45/004; F27D 11/06; B21B 2001/221

(57) ABSTRACT

Provided is an induction heating device for a metal plate including: a first conductor member that faces at least one of a front surface or a back surface of the metal plate and that is disposed across the metal plate in a width direction; a second conductor member that is separated from the first conductor member by a first distance in a plate passing direction of the metal plate, that faces at least one of the front surface or the back surface of the metal plate, and that is disposed across the metal plate in the width direction; connecting members that connect the first conductor member and the second conductor member to each other at positions separated from width-directional end portions of the metal plate to form a primary closed circuit; and an AC power supply connected to the primary closed circuit, in which the first distance is larger than a sum of dimensions of the first conductor member and the second conductor member in the plate passing direction of the metal plate.

### TECHNICAL FIELD

The present disclosure relates to an induction heating device for a metal plate, processing equipment for a metal plate, and an induction heating method of a metal plate.

### BACKGROUND ART

In cold rolling of a relatively hard steel material such as stainless steel or high tensile strength steel, since brittleness of the steel material is higher than usual, end cracking may occur at end portions in a width direction. For example, Japanese Patent Application Laid-Open (JP-A) No. 2010-221224 describes a technique for coping with such end cracking. More specifically, JP-A No. 2010-221224 describes a technique of preventing end cracking by induction-heating the end portions using a C-shaped inductor disposed so as to sandwich the end portions of the steel plate in the width direction from above and below to reduce deformation resistance of the steel plate at the end portions.

In a case of a thick steel material such as a hot-rolled slab, the end portions of the steel material cool before being extracted from a heating furnace, subjected to rough rolling, and subjected to finish rolling. Therefore, in order to improve rolling dimensional accuracy and stabilize a quality of the hot-rolled material, a transverse-type induction heating device such as the C-shaped inductor as described above is usually provided before a finish rolling mill.

In alloying of hot dip galvanizing and the like, for example, in order to prevent a decrease in an end portion temperature from resulting in poor alloying, JP-A No. 2009-149970 describes a temperature compensation device by flame including an end portion detection mechanism and a movement mechanism.

### SUMMARY OF INVENTION

### Technical Problem

JP-A No. 2010-221224 also describes that by providing a carriage that moves the inductor in the width direction of the steel plate and a position controller that controls the movement of the carriage, an appropriate overlapping length between the inductor and the steel plate is maintained in response to a change in a width of the steel plate and meandering during conveyance. However, as an earlier problem, in the case of the C-shaped inductor, a wide range other than the portion sandwiched by the inductor is induction-heated due to a magnetic flux leaking outside the inductor. In this regard, in order to prevent the end cracking of the metal plate, it is sufficient to heat a narrow range near the end portions of the metal plate in the width direction, and thus the technique described in JP-A No. 2010-221224 is not necessarily efficient at least in terms of power consumption. There is a problem that heating cannot be effectively performed unless an inductor gap is narrowed, and there is a concern that when a heated material has a poor shape such as a hot-rolled steel plate, the device may be damaged due to contact with the inductor. Ancillary equipment such as a detection mechanism or a movement mechanism control device for coping with meandering or the like is indispensable, and there is also a disadvantage in cost.

In a case where the end portions of the steel plate are heated by flame as in JP-A No. 2009-149970, there is a problem in capability that heating capability due to the flame is not large and heating efficiency is low, and a disadvantage that ancillary equipment such as an end portion detection mechanism or a movement mechanism is required.

Therefore, an object of the disclosure is to provide a technique for efficiently heating only a specific range of end portions of a metal plate in a width direction to increase a temperature of the end portions of the metal plate to stabilize a quality of the end portions even when a plate width of the metal plate is changed or the metal plate is conveyed in a meandering manner, and solving a problem caused by the temperature decrease of plate end portions such as prevention of end cracking of the metal plate, improvement of rolling dimensional accuracy, or avoidance of poor alloying.

### Solution to Problem

An aspect of the disclosure is an induction heating device for a metal plate, the induction heating device including: a first conductor member that faces at least one of a front surface or a back surface of the metal plate and that is disposed across the metal plate in a width direction; a second conductor member that is separated from the first conductor member by a first distance in a plate passing direction of the metal plate, that faces at least one of the front surface or the back surface of the metal plate, and that is disposed across the metal plate in the width direction; connecting members that connect the first conductor member and the second conductor member to each other at positions separated from width-directional end portions of the metal plate to form a primary closed circuit; and an AC power supply connected to the primary closed circuit, in which the first distance is larger than a sum of dimensions of the first conductor member and the second conductor member in the plate passing direction of the metal plate.

Another aspect of the disclosure is an induction heating method of a metal plate, the induction heating method including: a step of passing an AC current to a primary closed circuit formed by a first conductor member that faces at least one of a front surface or a back surface of the metal plate and that is disposed across the metal plate in a width direction, a second conductor member that faces at least one of the front surface or the back surface of the metal plate, that is separated from the first conductor member by a first distance in a plate passing direction of the metal plate, and that is disposed across the metal plate in the width direction, and connecting members that connect the first conductor member and the second conductor member to each other at positions separated from width-directional end portions of the metal plate; and in the metal plate, a step of induction-heating the width-directional end portions of the metal plate by allowing a secondary closed circuit formed by induced currents generated in regions respectively facing the first conductor member and the second conductor member to pass through the width-directional end portions of the metal plate.

### Advantageous Effects of Invention

According to the disclosure, it is possible to efficiently heat only a specific range of end portions of a metal plate in a width direction to increase an end portion temperature of the metal plate and stabilize a quality of the end portions even when a plate width of the metal plate is changed or the metal plate is conveyed in a meandering manner, and it is possible to solve a problem caused by a temperature decrease of plate end portions, such as prevention of end cracking of the metal plate, improvement of rolling dimensional accuracy, or avoidance of poor alloying.

### BRIEF DESCRIPTION OF DRAWINGS

FIG. 1 is a plan view of an induction heating device for a metal plate according to a first embodiment of the disclosure.

FIG. 2A is a side view of the induction heating device illustrated in FIG. 1 as viewed in a direction of an arrow 2A-2A.

FIG. 2B is a side view (side view corresponding to FIG. 2A) illustrating a modification of the induction heating device illustrated in FIG. 1.

FIG. 2C is a side view (side view corresponding to FIG. 2A) illustrating another modification of the induction heating device illustrated in FIG. 1.

FIG. 3 is a view conceptually illustrating induced currents generated in a metal plate in the examples of FIGS. 1 and 2A to 2C.

FIG. 4 is a plan view of an induction heating device for a metal plate according to a second embodiment of the disclosure.

FIG. 5 is a plan view of an induction heating device for a metal plate according to another example of the second embodiment of the disclosure.

FIG. 6A is a cross-sectional view for explaining a third embodiment of the disclosure.

FIG. 6B is a cross-sectional view for explaining the third embodiment of the disclosure.

FIG. 7A is a cross-sectional view for explaining another example of the third embodiment of the disclosure.

FIG. 7B is a cross-sectional view for explaining another example of the third embodiment of the disclosure.

FIG. 8A is a plan view of an induction heating device for a metal plate (narrow) according to a fourth embodiment of the disclosure.

FIG. 8B is a plan view of the induction heating device for a metal plate (wide) according to the fourth embodiment of the disclosure.

FIG. 9 is a side view of the induction heating device illustrated in FIG. 8A as viewed in a direction of an arrow 9-9.

FIG. 10 is a graph illustrating an analysis result for verifying an effect of heating width-directional end portions of the metal plate in the embodiment of the disclosure.

FIG. 11 is a graph illustrating an analysis result for verifying the effect of heating the width-directional end portions of the metal plate in the embodiment of the disclosure.

FIG. 12 is a side view for explaining a movable part used in the embodiment of the disclosure.

FIG. 13 is a side view illustrating a state in which a distance between conductor members is changed using the movable part in FIG. 12.

FIG. 14A is a side view for explaining a modification of the movable part used in the embodiment of the disclosure.

FIG. 14B is a view as viewed from a direction of an arrow 14B in FIG. 14A.

FIG. 15 is a side view illustrating a state in which a distance between conductor members is changed using the movable part in FIG. 12.

FIG. 16 is a plan view of a state in which the induction heating device according to the embodiment of the disclosure is applied to a thick metal.

FIG. 17 is a side view illustrating currents flowing through the width-directional end portions when the side surface of the thick metal illustrated in FIG. 16 is viewed.

FIG. 18 is a plan view of an induction heating device as still another example of the metal plate according to the second embodiment of the disclosure.

FIG. 19 is a plan view illustrating a state in which a circuit of the induction heating device of FIG. 18 is switched.

FIG. 20 is a schematic configuration view illustrating an example of processing equipment using the induction heating device for a metal plate according to the embodiment of the disclosure.

FIG. 21 is a schematic configuration view illustrating another example of the processing equipment using the induction heating device for a metal plate according to the embodiment of the disclosure.

FIG. 22 is a schematic configuration view illustrating another example of the processing equipment using the induction heating device for a metal plate according to the embodiment of the disclosure.

### DESCRIPTION OF EMBODIMENTS

Hereinafter, an embodiment of the disclosure will be described in detail with reference to the accompanying drawings. In the present specification and the drawings, components having substantially the same functional configuration are denoted by the same reference numerals, and redundant description is omitted.

### First Embodiment

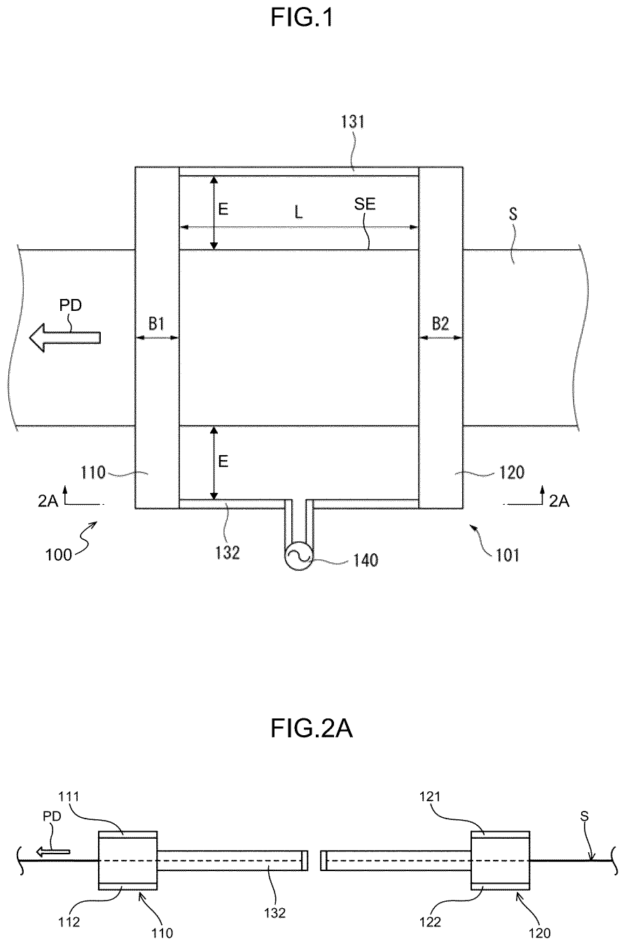

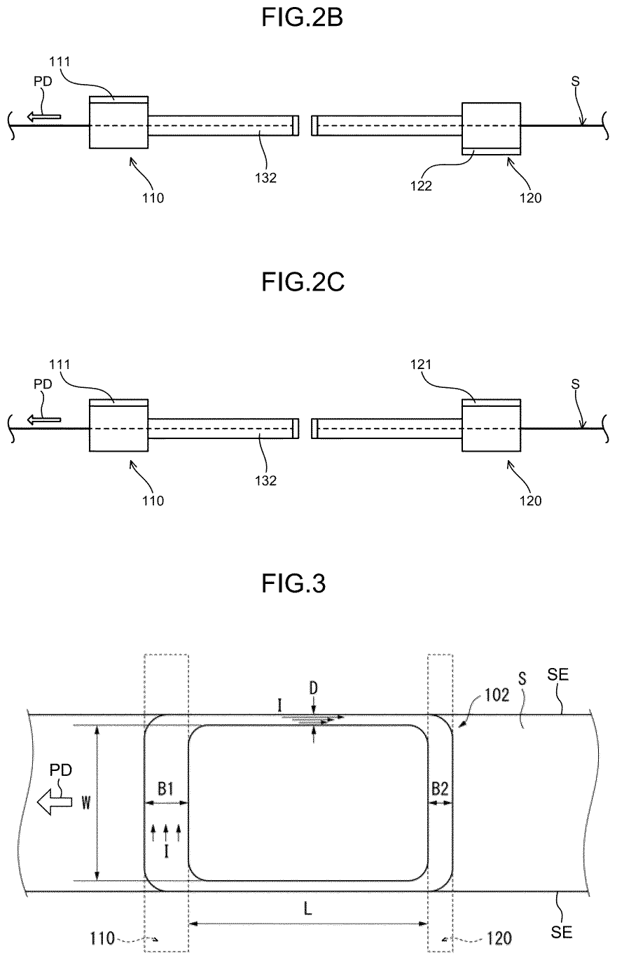

FIG. 1 is a plan view of an induction heating device for a metal plate according to a first embodiment of the disclosure, and FIG. 2A is a side view of the induction heating device illustrated in FIG. 1 as viewed in a direction of an arrow 2A-2A. As illustrated in FIGS. 1 and 2, an induction heating device 100 according to the present embodiment is a device that heats a metal strip S as a metal plate using electromagnetic induction. Here, the metal strip S used in the present embodiment is, for example, a belt-shaped thin plate, but the disclosure is not limited thereto.

The induction heating device 100 of the present embodiment includes conductor members 110 and 120, connecting members 131 and 132, and an AC power supply 140. The conductor member 110 faces at least one of a front surface or a back surface of the metal strip S and is disposed across the metal strip S in the width direction. Similarly to the conductor member 110, the conductor member 120 faces at least one of the front surface or the back surface of the metal strip S and is disposed across the metal strip S in the width direction. The conductor member 120 is separated from the conductor member 110 by a distance L in a plate passing direction (direction indicated by an arrow PD in FIG. 1) of the metal strip S. Here, the distance L is a distance between inner sides of the conductor members 110 and 120. The distance L (distance between inner sides) is larger than a sum of dimensions B1 and B2 of the conductor members 110 and 120 in the plate passing direction of the metal strip S (L>B1+B2). The distance L in the present embodiment is an example of a first distance in the disclosure.

In the connecting members 131 and 132, the conductor members 110 and 120 are connected to each other at positions separated from width-directional end portions of the metal strip S in plan view to form a primary closed circuit 101, and the AC power supply 140 is connected to the primary closed circuit 101. The connecting members 131 and 132 may be separated from width-directional end portions SE of the metal strip S having a maximum plate width. Specifically, a distance E from the connecting members 131 and 132 to the width-directional end portions SE of the metal strip S is preferably 3% or more and 12% or less, and more preferably 5% or more and 10% or less of a maximum width Wmax of the metal strip S. The relationship between the distance E and the maximum width Wmax desirably takes into consideration a meandering amount of a conveyance line on which the metal strip S is conveyed. When the distance E is less than 3% of the maximum width Wmax, the width-directional end portions SE of the metal strip S may meander to come into contact with the connecting member 131 or the connecting member 132. In this regard, when the distance E exceeds 12% of the maximum width Wmax, there are concerns about an increase in size of the device and an increase in an impedance of the primary closed circuit 101.

The conductor members 110 and 120 face at least one of the front surface or the back surface of the metal strip S. For this reason, a magnetic field generated around the conductor members 110 and 120 by the AC power supply 140 passing an AC current to the primary closed circuit 101 generates induced currents to be described later in the metal strip S.

Here, as illustrated in FIG. 2A, the conductor members 110 and 120 of the present embodiment both include two plate portions 111 and 112 and two plate portions 121 and 122 which face the front surface and the back surface of the metal strip S, respectively. In other words, the plate portions 111 and 112 of the conductor member 110 are disposed to face the front surface and the back surface of the metal strip S, respectively, and the plate portions 121 and 122 of the conductor member 120 are disposed to face the front surface and the back surface of the metal strip S, respectively. The disclosure is not limited thereto, and as in the example illustrated in FIG. 2B, the plate portion 111 of the conductor member 110 may face the front surface of the metal strip S, and the plate portion 122 of the conductor member 120 may face the back surface of the metal strip S, or the plate portion 112 of the conductor member 110 may face the back surface of the metal strip S, and the plate portion 121 of the conductor member 120 may face the front surface of the metal strip S. As in the example illustrated in FIG. 2C, both the plate portion 111 of the conductor member 110 and the plate portion 121 of the conductor member 120 may face only the front surface of the metal strip S, or both the plate portion 112 of the conductor member 110 and the plate portion 122 of the conductor member 120 may face only the back surface of the metal strip S. In other words, the conductor member 110 and the conductor member 120 are disposed to respectively face the same side surface of the metal strip S.

In the present embodiment, as illustrated in FIGS. 1 and 2A, the conductor members 110 and 120 and the connecting members 131 and 132 constitute an air-core coil. The primary closed circuit 101 constituted by the air-core coil is connected to the AC power supply 140.

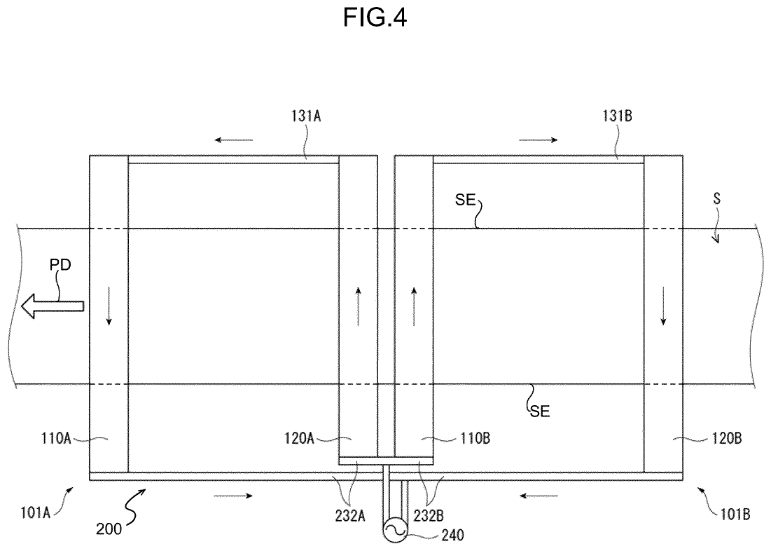

FIG. 3 is a view conceptually illustrating induced currents I generated in the metal strip S in the examples of FIGS. 1 and 2A. In the metal strip S, the secondary closed circuit 102 formed by the induced currents I generated in the regions respectively facing the conductor members 110 and 120 of the induction heating device 100 flows in the width direction of the metal strip S in the regions respectively facing the conductor members 110 and 120, and passes through the width-directional end portions SE of the metal strip S between both end portions of these regions. In this manner, the induced currents of the secondary closed circuit 102 circulate in the metal strip S. The induced currents I flowing through the secondary closed circuit 102 can suppress a calorific value because a current density is small at a central portion of the metal strip S, but the current density in a limited range from the end portion increases at the width-directional end portions SE due to a skin effect in which a high frequency current is concentrated at the end portions. As a result, the width-directional end portions SE of the metal strip S can be effectively heated.

As is clear from FIG. 3, in the disclosure, in the problem that a non-magnetic material cannot be heated due to a penetration depth of the current, which is a problem in a so-called LF heating method of heating a thin plate with a solenoid coil, the circulating currents do not overlap by shifting the conductors so as not to overlap each other in a traveling direction, and thus, it is possible to heat both a non-magnetic material and a magnetic material.

In addition, by separating the conductor members 110 and 120 by the distance L in the plate passing direction of the metal strip S, a time during which the heating of the width-directional end portions SE of the metal strip S is continued becomes long. Specifically, when a plate passing speed of the metal strip S is v, the heating is continued from when the width-directional end portions SE of the metal strip S pass under (or above) the conductor member 120 to when the width-directional end portions SE pass under (or above) the conductor member 110, so that a heating duration time is L/v. In this regard, at a width-directional center portion of the metal strip S, heating is performed only while passing under (or above) the conductor member 120 and while passing under (or above) the conductor member 110, so that the heating duration time is (B1+B2)/v. Therefore, by satisfying L>B1+B2, the heating duration time can be made longer in the width-directional end portions SE than in the width-directional center portion of the metal strip S. In this manner, a calorific value Qc of the width-directional center portion of the metal strip S and a calorific value Qe of the width-directional end portions SE can be adjusted by the distance L between the conductor members 110 and 120 and the respective dimensions B1 and B2. The calorific values Qc and Qe can also be adjusted by a frequency f of the AC current.

More specifically, the calorific value Qc of the width-directional center portion of the metal strip S can be calculated by the following Formula (1) using a plate width W, a plate thickness t, a specific resistance ρ1 of a portion facing the conductor member 110, and a specific resistance ρ2 of a portion facing the conductor member 120 of the metal strip S in addition to the above respective amounts.

$$\begin{matrix}[ Mathematical Formula 1 ] & \\ Qc = {I}^{2} \times \frac{W}{B 1 \times t} \cdot ρ 1 \times \frac{B 1}{v} + {I}^{2} \times \frac{W}{B 2 \times t} \cdot ρ 2 \times \frac{B 2}{v} = {I}^{2} \times ( \frac{W}{v \times t} ) ( ρ 1 + ρ 2 ) & ( 1 )\end{matrix}$$

In this regard, the calorific value Qe (sum of both sides) of the width-directional end portions SE of the metal strip S can be calculated by the following Formula (2) using a specific resistance pe at the width-directional end portions SE of the metal strip S in addition to the above-described respective amounts.

$$\begin{matrix}[ Mathematical Formula 2 ] & \\ Q e = 2 \times {I}^{2} \times \frac{L}{D \times t} \cdot ρ e \times \frac{L}{v} = 2 {I}^{2} \times \frac{{L}^{2}}{D \times t \times v} \cdot ρ e & ( 2 )\end{matrix}$$

A ratio between the calorific value Qc of the width-directional center portion and the calorific value Qe of the width-directional end portions SE of the metal strip S is expressed by the following Formula (3) from the above Formulas (1) and (2).

$$\begin{matrix}[ Mathematical Formula 3 ] & \\ \frac{Q e}{Q c} = \frac{2 {L}^{2}}{D \times W} \times \frac{ρ e}{ρ 1 + ρ 2} & ( 3 )\end{matrix}$$

From the above Formula (3), the conditions for intensively heating the width-directional end portions SE while suppressing the temperature rise of the width-directional center portion of the metal strip S will be examined. When ρ1=ρ2=pc in Formula (3), the following Formula (4) is obtained.

$$\begin{matrix}[ Mathematical Formula 4 ] & \\ \frac{Qe}{Q c} = \frac{{L}^{2}}{D \times W} \times \frac{ρ e}{ρ c} & ( 4 )\end{matrix}$$

Here, the calorific values Qc and Qe are represented by the following Formulas (5) and (6) using a specific gravity γ of the metal strip S, specific heats Cpc and Cpe, temperature rise amounts ΔTc and ΔTe of each of the width-directional center portion and the width-directional end portions SE, and an average dimension B=(B1+B2)/2 of the conductor members. When Formulas (5) and (6) are substituted into the Formula (4) and rearranged, Formulas (7) and (8) are obtained.

$$\begin{matrix}[ Mathematical Formula 5 ] & \\ Qc = 2 \times γ \times W \times B \times t \times Cpc \times Δ Tc & ( 5 )\end{matrix}$$

$$Qc = 2 \times γ \times L \times D \times t \times Cpc \times Δ Tc \qquad ( 6 )$$

$$\frac{Δ Te}{Δ Tc} = \frac{L \times B}{{D}^{2}} \times \frac{Cpc}{Cpe} \times \frac{ρ e}{ρ c} \qquad ( 7 )$$

$$L = \frac{Δ Te}{Δ Tc} \times \frac{{D}^{2}}{B} \times \frac{Cpe}{Cpc} \times \frac{ρ c}{ρ e} \qquad ( 8 )$$

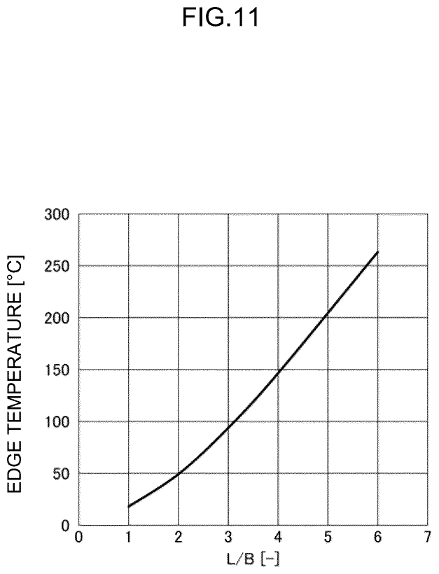

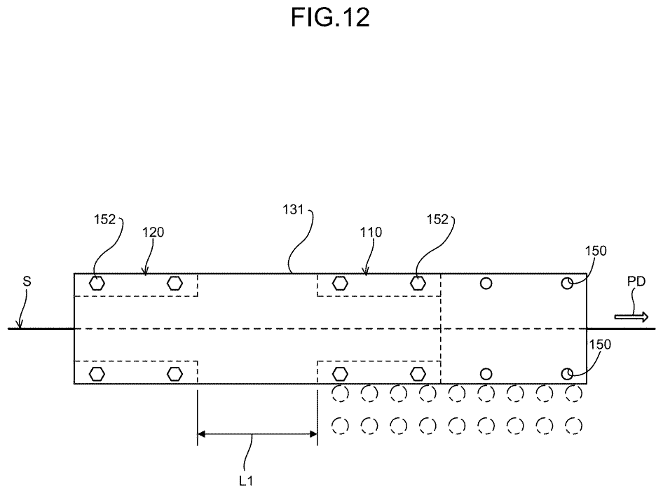

In the above Formula (8), when B=0.1 m and D=0.07 m, and ΔTe of the width-directional end portions SE is set to 500° C. while the temperature rise amount ΔTc of the width-directional center portion of the metal strip S is suppressed to 10° C., an appropriate distance L is obtained as follows by substituting the specific heats Cpc and Cpe and the specific resistances pc and pe corresponding to the respective temperature rise amounts. In order to set the appropriate distance L according to the conditions, the connecting members 131 and 132 of the induction heating device 100 may include a movable part capable of moving at least one of the conductor members 110 or 120 in the plate passing direction of the metal strip S. As an example of the movable part of the disclosure, movable parts 150 illustrated in FIGS. 12 and 13 may be used. The movable parts 150 are a plurality of bolt holes provided in the connecting members 131 and 132 (only the connecting member 131 is illustrated in FIGS. 12 and 13) that respectively connects the conductor members 110 and 120. The plurality of bolt holes are provided in the connecting members 131 and 132 at intervals in the plate passing direction. By changing attachment positions of the conductor members 110 and 120, specifically, by changing attachment positions of the conductor members 110 and 120 by bolts 152, a distance between the conductor members 110 and 120 can be changed. For example, when the conductor members 110 and 120 are moved from the positions illustrated in FIG. 12 to the positions illustrated in FIG. 13, the distance between the conductor members 110 and 120 increases from a distance L1 to a distance L2. When the attachment positions of the conductor members 110 and 120 are changed, the movement of the conductor members 110 and 120 is simplified by disposing a roller (a member indicated by a two-dot chain line in FIG. 12) or the like under the conductor members 110 and 120.

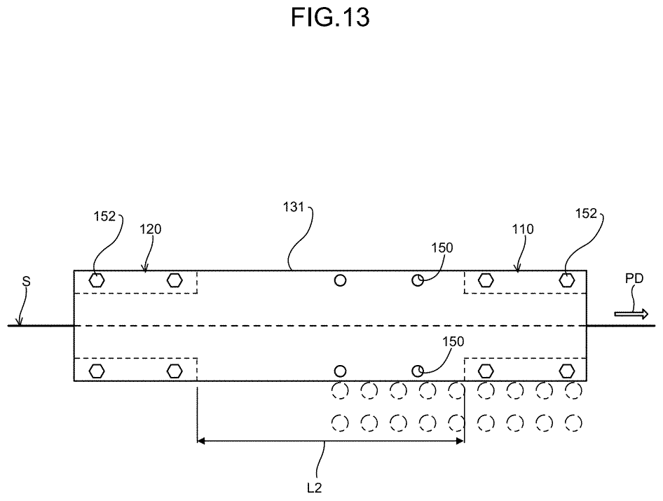

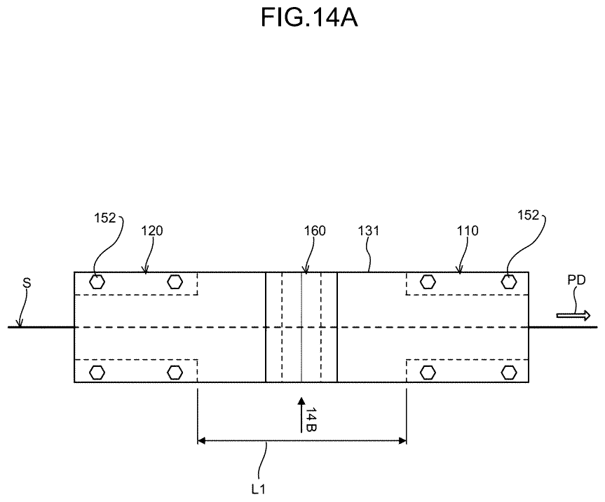

As another example of the movable part of the disclosure, a movable part 160 illustrated in FIGS. 14A and 15 may be used. The movable part 160 is a stretchable portion constituting the connecting members 131 and 132 (only the connecting member 131 is illustrated in FIGS. 12 and 13) that respectively connects the conductor members 110 and 120. The stretchable portion is formed of, for example, a flexible conductor such as a knitted wire. As illustrated in FIG. 15, the stretchable portion constitutes a central portion of each of the connecting members 131 and 132 in the plate passing direction. Specifically, it connects plate portions 131A and 132A of the connecting members 131 and 132 connected to the conductor members 110 and 120. As illustrated in FIG. 14B, the stretchable portion is curved in a mountain shape toward the side opposite to the metal strip S side. As illustrated in FIG. 15, the curved stretchable portion expands and contracts, so that the positions of the conductor members 110 and 120 in the plate passing direction move. When the positions of the conductor members 110 and 120 in the plate passing direction are changed, the movement of the conductor members 110 and 120 is simplified by disposing a roller or the like under the conductor members 110 and 120. The flexible conductor constituting the stretchable portion may be a water-cooled cable.

$$L = \frac{500}{10} \times \frac{{0.07}^{2}}{0.1} \times \frac{0.13}{0.112} \times \frac{0.14}{0.36} = 0.81 [ m ] \qquad [ Mathematical Formula 6 ]$$

With respect to the frequency f [kHz] of the AC current, according to the results of the analysis performed by the present discloser, a range D [mm] from an edge where 70% of an input power contributes to the temperature rise is represented, for example, as the following Formula (9) in relation to the induced current I.

$$\begin{matrix}[ Mathematical Formula 7 ] & \\ D = - 15 \times ln ( f ) + 107 [ mm ] & ( 9 )\end{matrix}$$

According to the configuration of the first embodiment of the disclosure as described above, the entire metal strip S in the width direction is heated only while passing under (or above) the conductor members 110 and 120 of the induction heating device 100. The heating range between the conductor members 110 and 120 is limited to the width-directional end portions SE of the metal strip S. This makes it possible to reduce the input power and avoid unnecessary influence on a metallographic structure. That is, in the present embodiment, the end portions SE of the metal strip S in the width direction can be efficiently heated, and the end cracking of the metal strip S at the time of cold rolling or the like can be prevented. In the above configuration, since there is no member that needs to be disposed close to the width-directional end portions SE which are heating portions of the metal strip S, and the circulating current is generated by the induced current generated while passing under (or above) the conductor members 110 and 120, it is possible to cope with meandering of the metal strip S in the width direction and a change in the plate width and the plate thickness without changing the arrangement of the members, and it is possible to perform heating even when a shape defect occurs in the metal strip S.

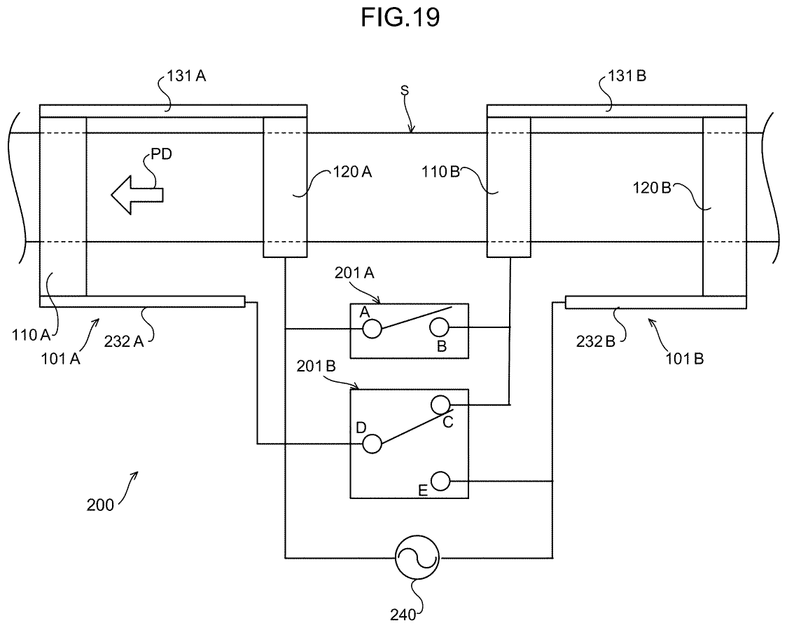

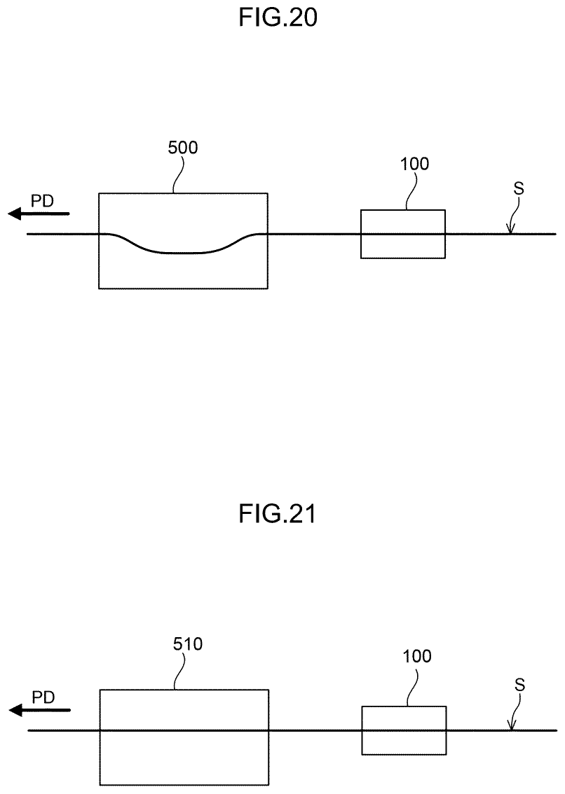

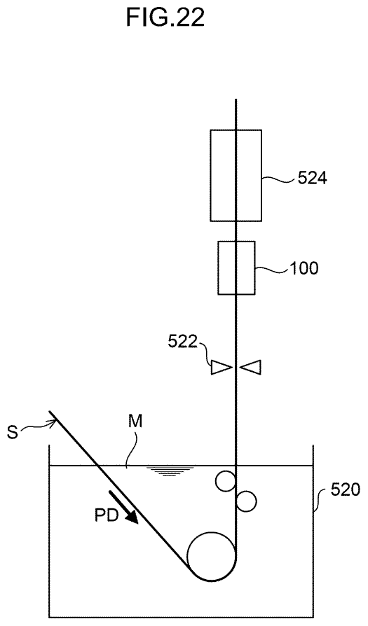

Here, the end cracking of the metal strip occurs, for example, in a pickling step or a cold rolling step after a hot rolling step. Therefore, the induction heating device 100 may be disposed, for example, at a preceding stage of a pickling device 500 in processing equipment including the pickling device 500 (see FIG. 20) for the metal strip S, or may be disposed at a preceding stage of a cold rolling device 510 in processing equipment including the cold rolling device 510 (see FIG. 21) for the metal strip S. The end cracking of the metal strip also occurs, for example, in a molten metal plating step. Therefore, the induction heating device 100 may be disposed between a wiping device 522 and an alloying heating device 524 in processing equipment including, for example, a plating tank 520 in which a molten metal M (molten zinc as an example) illustrated in FIG. 22 is stored, the wiping device 522 that blows gas (for example, air) to the metal strip S to which the molten metal M is attached, and the alloying heating device 524 that raises the temperature of the molten metal M attached to the metal strip S to an alloying temperature by heating and holds the temperature to alloy the molten metal M.

### Second Embodiment

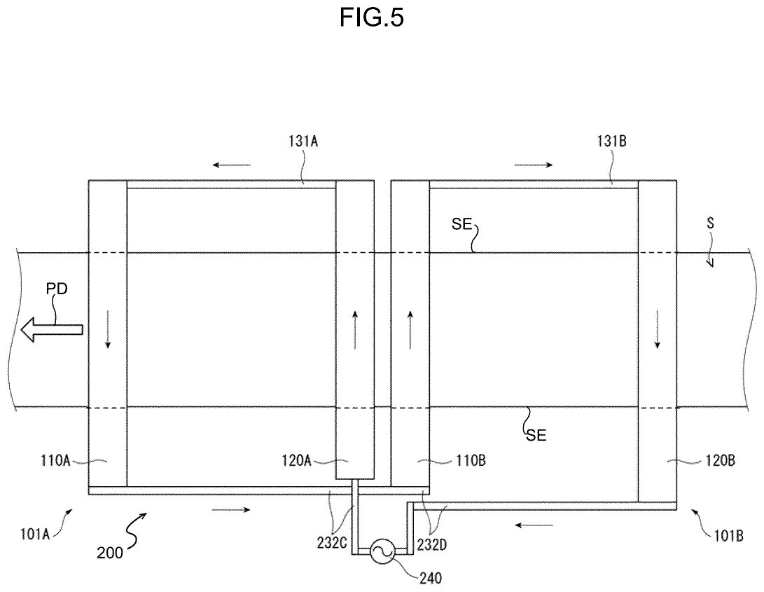

FIG. 4 is a plan view of an induction heating device for a metal strip according to a second embodiment of the disclosure. As illustrated, an induction heating device 200 according to the present embodiment is configured by a parallel circuit including conductor members 110A and 120A and connecting members 131A and 232A forming a primary closed circuit 101A, conductor members 110B and 120B and connecting members 131B and 232B forming a primary closed circuit 101B, and an AC power supply 240. The primary closed circuits 101A and 101B are disposed adjacent to each other in the plate passing direction (direction indicated by an arrow PD in FIG. 4) of the metal strip S. In each of the primary closed circuits 101A and 101n, the configurations of the conductor members 110A and 110B and the conductor members 120A and 120B are similar to those of the conductor members 110 and 120 in the first embodiment. The conductor member 120A constituting the primary closed circuit 101A and the conductor member 110B constituting the primary closed circuit 101B are disposed adjacent to each other in the plate passing direction of the metal strip S, and pass in-phase currents.

The connecting members 131A and 131B connect the conductor members 110A and 120A and the conductor members 110B and 120B to each other at positions separated from the width-directional end portions SE of the metal strip S in plan view to form the primary closed circuits 101A and 101B, respectively. The connecting members 232A and 232B respectively connect the conductor members 110A and 120A and the conductor members 110B and 120B to each other at positions separated by a distance E from the width-directional end portions SE of the metal strip S to form the primary closed circuits 101A and 101B, and connect the primary closed circuits 101A and 101B in parallel to the AC power supply 240. The AC power supply 240 is connected to the primary closed circuits 101A and 101B so that the in-phase AC currents are passed to the conductor members adjacent to each other in the plate passing direction of the metal strip S, that is, the conductor member 120A and the conductor member 110B.

According to the configuration of the second embodiment of the disclosure as described above, in addition to obtaining the same effects as those of the first embodiment, the appropriate distance L can be set as the sum of the primary closed circuits 101A and 101B. As a result, when the primary closed circuits 101A and 101B are connected in parallel, an inductance of each primary closed circuit can be reduced to about half as compared with a case where the distance L is set with a single primary closed circuit. By passing the in-phase AC currents to conductor member 120A and the conductor member 110B adjacent to each other, the magnetic fluxes generated around the conductor members are in the same direction, and the magnetic fluxes are likely to concentrate on the metal strip S.

Specifically, when the primary closed circuit 101A (inductance L1, impedance Z1) configured by one set of conductor members 110A and 120A and the primary closed circuit 101B (inductance L2, impedance Z2) configured by another set of conductor members 110B and 120B are connected in parallel, a parallel combined inductance L is obtained by the following Formula (10).

$$L = L 1 \times L 2 / L 1 + L 2 \qquad ( 10 )$$

In general, when the parallel connection is made, the inductance and the impedance can be reduced. When the inductance L1 and the inductance L2 are substantially equal, the inductance is about half according to the above Formula (10).

In particular, when the plate passing speed of the metal strip S (usually a thin material) is high and a sufficient heating time cannot be taken, a separation distance of a set of conductor members to be installed becomes long, the inductance and the impedance become large, a burden of the power supply becomes large such as increase in voltage, and equipment cost increases and a safety problem occurs.

The parallelization makes it possible to reduce the inductance even when the required separation length is long, so that it is possible to solve the safety problem associated with the reduction of the power load and the increase in voltage.

Even in a case where large electric power is input without increasing the separation distance, the current is shunted, so that heat generation of one set of conductor members can be reduced and efficiency can be increased.

As indicated below, a resonance frequency f of the current is increased.

$$\begin{matrix}[ Mathematical Formula 8 ] & \\ f = \frac{1}{2 π \sqrt{LC}} & ( 11 )\end{matrix}$$

L is an inductance [H], and C is a capacitor capacitance [F].

When the resonance frequency increases, the heating range of the width-directional end portions SE of the metal strip S can be narrowed, and the limited range of the width-directional end portions SE can be effectively heated.

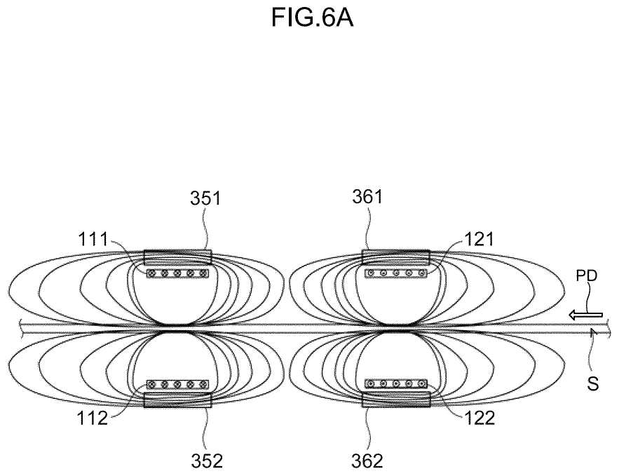

FIG. 5 is a plan view of an induction heating device for a metal strip according to another example of the second embodiment of the disclosure. As a difference from the above example, in the illustrated example, connecting members 232C and 232D connect the primary closed circuits 101A and 101B in series to the AC power supply 240. The same applies in that in-phase AC currents are passed to the conductor member 120A and the conductor member 110B adjacent to each other in the plate passing direction of the metal strip S. By connecting the primary closed circuits 101A and 101B in series, magnitudes of the currents flowing through the primary closed circuits can be made the same. An oscillation condition can be changed by increasing the inductance.

Specifically, when the series connection is made, a combined inductance L is expressed by the following Formula.

$$L = L 1 + L 2 \qquad ( 12 )$$

The series connection increases the inductance and decreases the frequency.

When the frequency is lowered, a penetration depth 6 of the current can be deepened. Therefore, particularly in a case of a material having a large plate thickness, a heating range in a thickness direction can be widened, and a heating range from the width-directional end portions SE of the metal strip S can also be widened.

$$\begin{matrix}[ Mathematical Formula 9 ] & \\ δ = 5.03 \sqrt{\frac{ρ}{μ r \times f}} & ( 13 )\end{matrix}$$

ρ is a specific resistance [μΩcm], r is a relative permeability, and f is a frequency [Hz].

Since all the currents flowing through the conductor members are the same, an amount of edge heating for each closed circuit can be the same even when the impedances are different.

As described above, when the parallel/series connection can be freely performed, there is an advantage that the frequency, the current/power distribution, and the heating range of the width-directional end portions of the metal strip, which are appropriately required according to the load, can be relatively freely changed and a plurality of individual equipment need not be prepared.

In general, in a case where a plate thickness is thin, a plate passing speed is fast, and a temperature change of a specific resistance is small (SUS304 or the like), since the change in the impedance is small and the power/current amount is large before and after the heating, parallel connection capable of reducing the heat generation of the conductor is desirable. In a case where there is an impedance difference before and after the heating, such as ordinary steel having a large temperature change of the specific resistance, or in a case of a thick steel material having a low plate passing speed, series connection in which the current amount between the circuits is the same, the inductance is large, and heating on the low frequency side is easy is desirable.

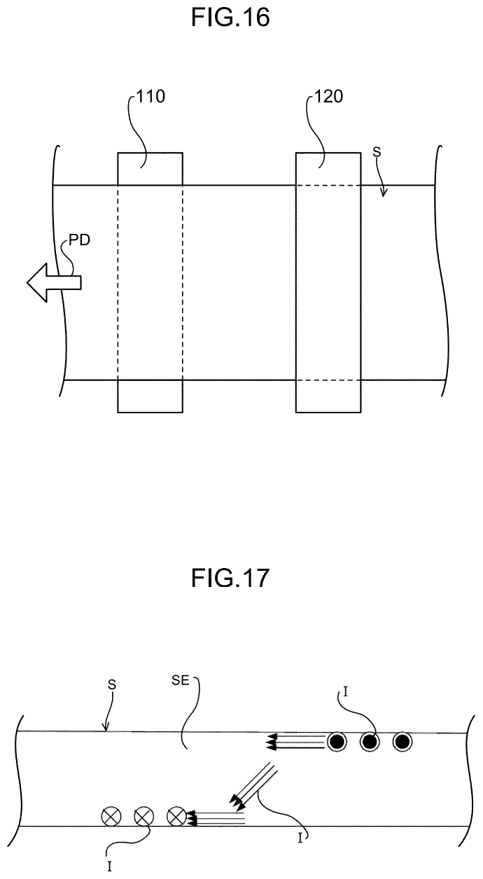

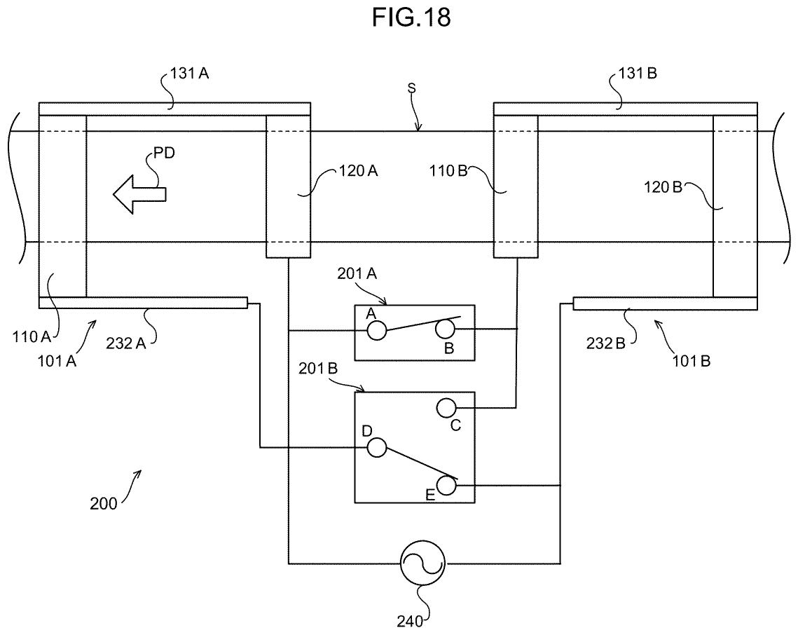

The induction heating device 200 may manually switch between the series connection and the parallel connection of the primary closed circuits 101A and 101B, or may include a switching circuit that automatically switches between them. The switching circuit includes, for example, a switch that selectively connects the AC power supply 240 to any one of the connecting members 232A and 232B illustrated in FIG. 4 or the connecting members 232C and 232D illustrated in FIG. 5. As an example, a switch 201A and a switch 201B illustrated in FIGS. 18 and 19 may be used to switch between the parallel connection (connection in FIG. 18) and the series connection (connection in FIG. 19). In FIG. 18, a contact A of the switch 201A connected to the conductor member 120A and a contact B of the conductor member 110B are short-circuited. A contact D of the switch 201B connected to the connecting member 232A and a contact E connected to the connecting member 232B are short-circuited. As a result, the primary closed circuit 101A and the primary closed circuit 101B are connected in parallel. In this regard, in FIG. 19, the contact A of the switch 201A connected to the conductor member 120A is released from the contact B of the conductor member 110B. Then, the primary closed circuit 101A and the primary closed circuit 101B are connected in series by short-circuiting the contact D of the switch 201B connected to the connecting member 232A and the contact C connected to the conductor member 110B.

### Third Embodiment

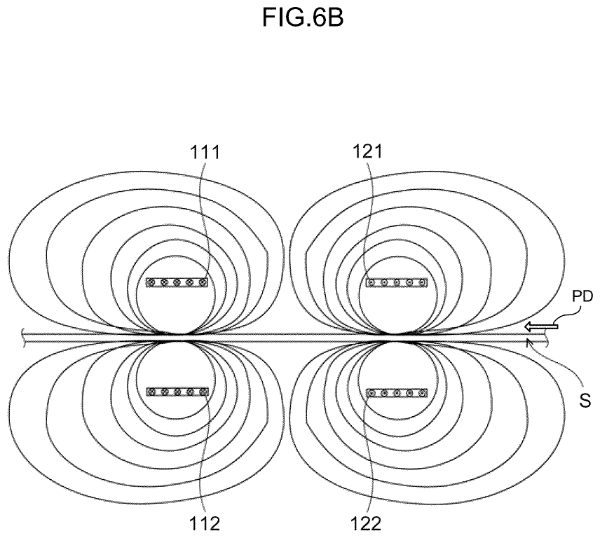

FIGS. 6A and 6B are cross-sectional views for explaining a third embodiment of the disclosure. As illustrated in FIG. 6A, in the present embodiment, magnetic cores 351, 352, 361, and 362 are disposed on the surfaces of the plate portions 111, 112, 121, and 122 constituting the conductor members on the sides opposite to the metal strip S. As a result, the magnetic fluxes freely circulating on the side opposite to the metal strip S of the plate portions 111, 112, 121, and 122 constituting the conductor members pass through the magnetic cores 351, 352, 361, and 362 having high magnetic permeability in a concentrated manner as compared with the case where the magnetic cores are not disposed as illustrated in FIG. 6B, so that the magnetic fluxes concentrate and easily enter the metal strip S immediately below the conductor members 111, 112, 121, and 122, and the metal strip S can be induction-heated more effectively. In the present embodiment, with the arrangement of the magnetic cores as described above, the magnetic fluxes generated by the currents flowing through the conductors can be concentrated on the plate portions 111, 112, 121, and 122 of the conductor members, so that the gap with the metal strip S can be increased, and for example, it can correspond to a waveform shape of the metal strip S in the thickness direction. In the present embodiment, since a leakage magnetic flux toward the back side (the side not facing the metal strip S) of the conductor member is reduced by the arrangement of the magnetic cores, it is possible to prevent, for example, a member that supports the conductor member or a device installed in the periphery from being heated.

The magnetic core only needs to secure an appropriate cross-sectional area that is not magnetically saturated. For example, in the case of using a high frequency, a ferrite core having a small cross-sectional area even when the saturation magnetic flux density is small may be used, and a ferromagnetic material such as a laminated electromagnetic steel plate or amorphous having a large saturation magnetic flux density may be used in the case of a relatively low frequency. When heat generation is concerned, it is desirable to appropriately provide a cooling device such as a water-cooled copper plate to cool the magnetic core.

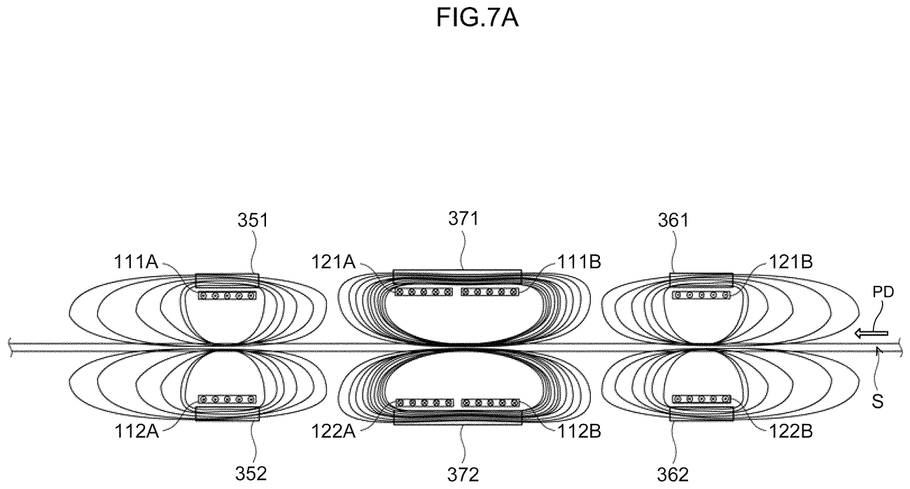

FIGS. 7A and 7B are cross-sectional views for explaining another example of the third embodiment of the disclosure. FIG. 7B includes only plate portions 111A, 111B, 112A, 112B, 121A, 121B, 122A, and 122B constituting the conductor members, but in the case of FIG. 6B, which is a single closed circuit, the magnetic fluxes are freely radiated in a front-rear direction in the traveling direction (the same as the plate passing direction) of the metal strip S, so that the magnetic fluxes are less likely to concentrate. On the other hand, in another example of the third embodiment, in a case where in-phase currents are caused to flow through the plate portions 111A, 111B, 112A, and 112B at the central portions of the two closed circuits, the magnetic fluxes generated in the plate portions 111A, 111B, 112A, and 112B cannot narrow the range in which it can fly in the front-rear direction in a longitudinal direction (the same as the plate passing direction) of the metal strip S due to the magnetic fluxes of the opposite phase generated in the plate portions 111A, 112A, 121B, and 122B, and the magnetic fluxes are confined in the vicinity of the plate portions 111A, 111B, 112A, and 112B, so that the induced currents can be efficiently concentrated. As illustrated in FIG. 7A, in the present embodiment, when the magnetic cores 351, 352, 361, 362, 371, and 372 are disposed on the surface of the plate portions 111A, 111B, 112A, 112B, 121A, 121B, 122A, and 122B constituting the conductor members on the sides opposite to the metal strip S, the induced currents can be more efficiently concentrated. Here, the magnetic cores 371 and 372 may be divided in the middle in the longitudinal direction and the width direction as long as they are close to each other, but it is desirable that they are disposed in common on each of the two plate portions 121A and 111B and the plate portions 122A and 122B of the conductor members adjacent to each other in the plate passing direction of the metal strip S. That is, the magnetic core 371 covers both the back sides of the plate portions 121A and 111B of the conductor member, and the magnetic core 372 covers both the back sides of the plate portions 122A and 112B of the conductor member. As a result, for example, even when the plurality of primary closed circuits are disposed adjacent to each other in the plate passing direction of the metal strip S as in the examples of FIGS. 4 and 5, the magnetic fluxes easily enter the metal strip S as compared with the case where the magnetic cores are not disposed as illustrated in FIG. 7B. As a result, the metal strip S can be more effectively induction-heated. The gap between the conductor member and the metal strip S can be increased, and the leakage magnetic flux can be reduced similarly to the above example.

### Fourth Embodiment

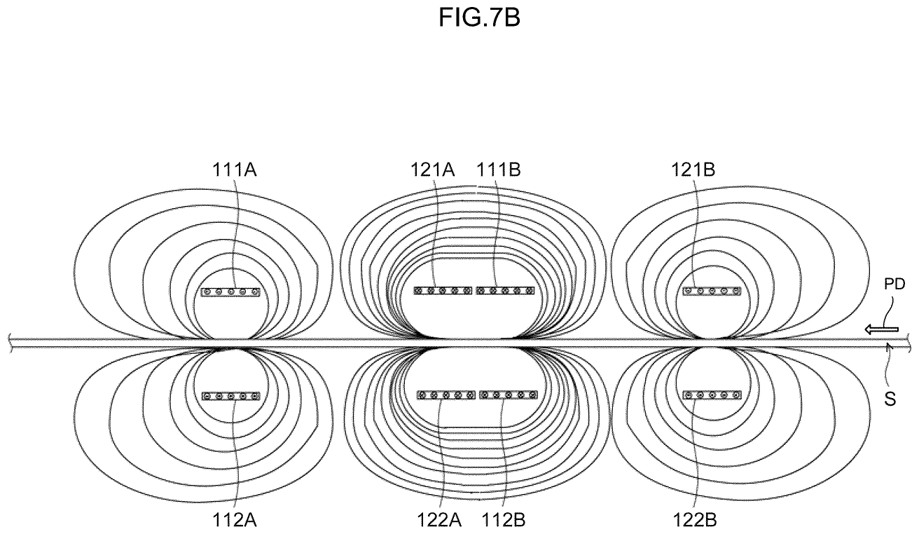

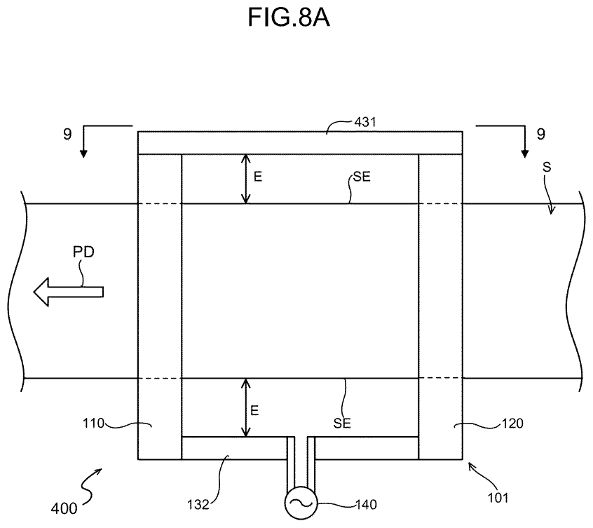

FIG. 8A is a plan view of an induction heating device for a metal strip according to a fourth embodiment of the disclosure, and FIG. 9 is a side view of the induction heating device illustrated in FIG. 8A as viewed in a direction of an arrow 9-9. As illustrated, an induction heating device 400 according to the present embodiment includes conductor members 110 and 120 and connecting members 132 and 431 forming the primary closed circuit 101, and the AC power supply 140. As a difference from the first embodiment, in the present embodiment, the connecting members 431 and 132 are disposed on an upper surface or a lower surface on the end portion side of the metal strip S so as not to interfere with the metal strip S in the thickness direction of the metal strip S. Specifically, for example, as illustrated in the example of FIG. 9, the plate portions 111 and 121 of the conductor member on the front surface side of the metal strip S and the plate portion 112 and 122 of the conductor member on the back surface side are respectively connected by the connecting member 431, and the conductor members are not connected between the front surface side and the back surface side of the metal strip S.

According to the fourth embodiment of the disclosure as described above, in addition to obtaining the effects similar to those of the first embodiment, even in a case where it is necessary to perform maintenance by removing the induction heating device 400 from the conveyance line of the metal strip S, even when the induction heating device is pulled out downward in the drawing (power supply side), it is not necessary to stop and cut the metal strip S being conveyed even during operation, and maintenance can be easily performed.

In the above-described embodiment, the connecting members 131 and 132 are separated from the width-directional end portions SE of the metal strip S, but the disclosure is not limited to this configuration. As illustrated in FIG. 8B, the connecting members may overlap the width-directional end portions SE of the metal strip S in plan view (for example, the connecting members may overlap the width-directional end portions SE of the metal strip S by about several tens mm). Specifically, the connecting members are disposed so as to partially overlap the width-directional end portions SE of the metal strip S in plan view with respect to the maximum plate width of a heated material that treats the connecting members above and below the conductor members 110 and 120. With such a configuration, it is possible to avoid contact between the connecting members and the width-directional end portions of the metal strip S. A width dimension of the connecting members may be a width dimension or more of the conductor members 110 and 120. With such a configuration, even when the metal strip S meanders, it is possible to uniformly flow the currents in the width-directional end portions SE of the metal strip S.

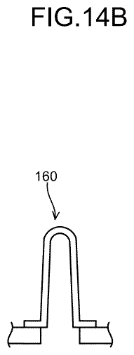

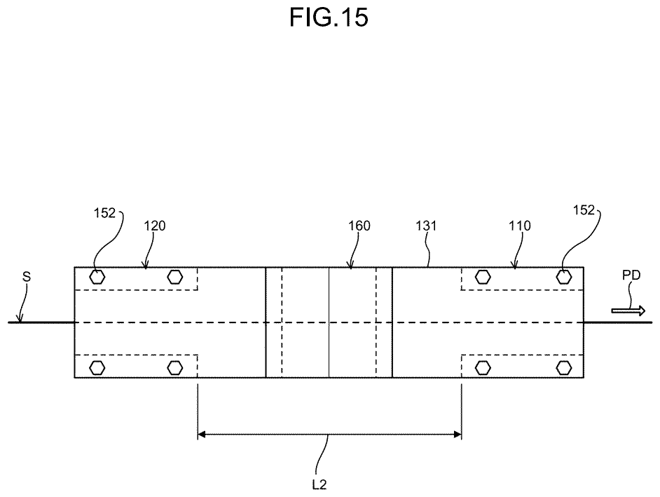

In the above embodiment, the metal strip S which is a thin plate is used as the metal plate, but the disclosure is not limited thereto. A thick metal such as a thick plate or a slab may be used as the metal plate. Even in this case, the effects of the disclosure can be obtained similarly to the first embodiment. Although the case where the heated material is moving has been exemplified, the heated material can also be applied in a stationary state. FIG. 17 illustrates a current flow on the side surface of the thick metal in a state where currents flow through the thick metal by the induction heating device of the disclosure (see FIG. 16).

### (Verification of Heating Effect)

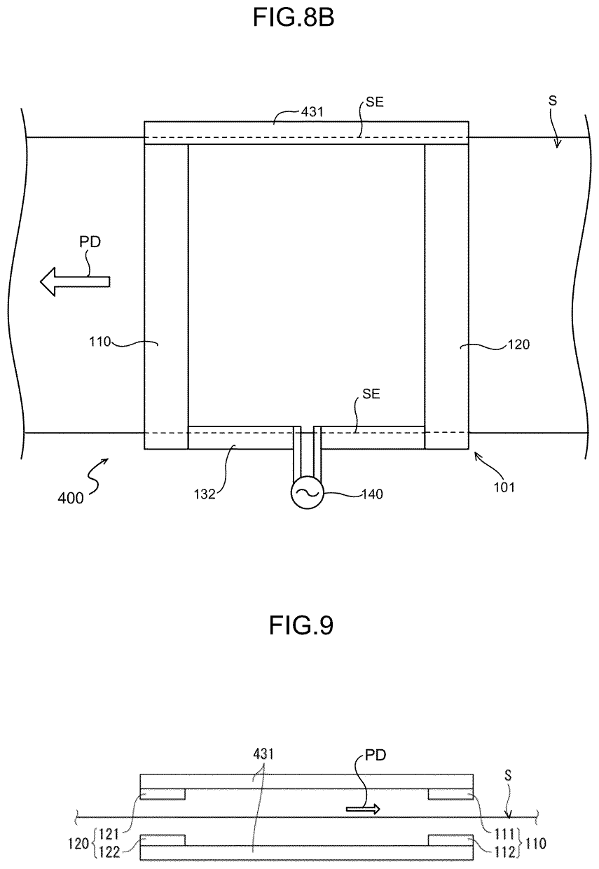

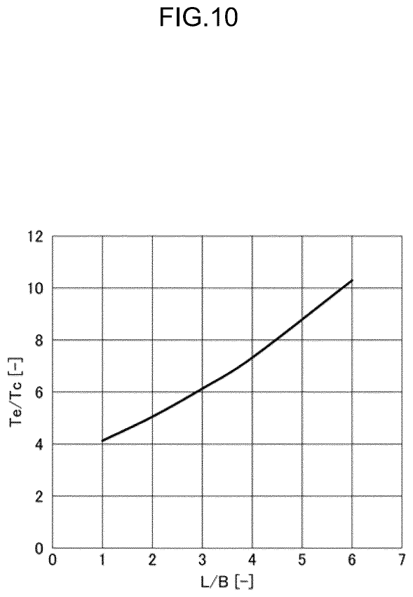

FIGS. 10 and 11 are graphs illustrating analysis results for verifying the effects of heating the width-directional end portions of the metal strip in the embodiment of the disclosure. The induction heating device as described above with reference to FIGS. 1 to 3 was subjected to electromagnetic field analysis by a finite element method under the following conditions to calculate a ratio between a temperature Tc at the width-directional center portion and a temperature Te at the width-directional end portion of the metal strip, and a temperature (edge temperature) at the width-directional end portion.
Plate width W of metal strip=1200 mm
Thickness t of metal strip=2 mm
Width B of conductor member=200 mm
Frequency f of AC current=10 kHz
Magnitude of AC current=10 kA
Distance L between conductor members=variable between 200 mm and 600 mm
Temperature T₀ of the metal strip before heating=0° C.

In the above analysis, when the distance L between the conductor members is minimized (100 mm), a ratio L/B of the width B to the distance L of the conductor members is 1. As illustrated in the graph of FIG. 10, when the ratio L/B is in a range of 1 or more, the temperature Te at the width-directional end portion of the metal strip greatly exceeds the temperature Tc at the central portion. In this regard, as illustrated in the graph of FIG. 11, the edge temperature is low when the ratio L/B is in a range of 1 or more and 2 or less, but when the ratio L/B exceeds 2, the edge temperature exceeds 50° C., and the edge temperature increases as the ratio L/B increases. The fact that the ratio L/B exceeds 2 (L/B>2) is equivalent to the fact that the distance L exceeds a total width of the two conductor members (L>2B). Under such conditions, the induction heating device can efficiently heat the end portions of the metal strip in the width direction.

The preferred embodiments of the disclosure have been described in detail above with reference to the accompanying drawings, but the disclosure is not limited to these examples. It is obvious that a person skilled in the art to which the disclosure belongs can conceive various changes or modifications within the scope of the technical idea described in the claims, and it is naturally understood that these also belong to the technical scope of the disclosure.

With regard to the above embodiments, the following supplementary notes are further disclosed.

### (Supplementary Note 1)

An induction heating device for a metal plate, the induction heating device including:
a first conductor member that faces at least one of a front surface or a back surface of the metal plate and that is disposed across the metal plate in a width direction;
a second conductor member that is separated from the first conductor member by a first distance in a plate passing direction of the metal plate, that faces at least one of the front surface or the back surface of the metal plate, and that is disposed across the metal plate in the width direction;
connecting members that connect the first conductor member and the second conductor member to each other to form a primary closed circuit; and
an AC power supply connected to the primary closed circuit, wherein
the first distance is larger than a sum of dimensions of the first conductor member and the second conductor member in the plate passing direction of the metal plate.

### (Supplementary Note 2)

The induction heating device described in supplementary note 1, in which the first conductor member and the second conductor member are disposed to face a same side surface of the metal plate.

### (Supplementary Note 3)

The induction heating device described in supplementary note 2, in which the first conductor member and the second conductor member are disposed at a front surface side and a back surface side of the metal plate, respectively.

### (Supplementary Note 4)

The induction heating device for a metal plate described in any one of supplementary notes 1 to 3, in which
first and second primary closed circuits each formed by the first conductor member, the second conductor member, and the connecting members are disposed adjacent to each other in the plate passing direction of the metal plate, and
the AC power supply passes in-phase AC currents to conductor members adjacent to each other in the plate passing direction of the metal plate in the first and second primary closed circuits.

### (Supplementary Note 5)

The induction heating device for a metal plate described in supplementary note 4, further including a switching circuit switchable between series connection and parallel connection of the first and second primary closed circuits.

### (Supplementary Note 6)

The induction heating device for a metal plate described in any one of supplementary notes 1 to 5, further including a magnetic core disposed on a surface of at least one conductor member of the first conductor member or the second conductor member on a side opposite to the metal plate.

### (Supplementary Note 7)

The induction heating device for a metal plate described in any one of supplementary notes 1 to 6, in which the connecting members are disposed on at least one side of the metal plate in the width direction so as not to interfere with the metal plate in a thickness direction of the metal plate.

### (Supplementary Note 8)

The induction heating device for a metal plate described in any one of supplementary notes 1 to 7, in which the connecting members includes a movable part capable of moving at least one conductor member of the first conductor member or the second conductor member in the plate passing direction of the metal plate.

### (Supplementary Note 9)

Processing equipment for a metal plate, the processing equipment including:
a pickling device for the metal plate; and
the induction heating device for a metal plate described in any one of supplementary notes 1 to 8, the induction heating device being disposed at a preceding stage of the pickling device.

### (Supplementary Note 10)

Processing equipment for a metal plate, the processing equipment including:
a cold rolling device for the metal plate; and
the induction heating device for a metal plate described in any one of supplementary notes 1 to 8, the induction heating device being disposed at a preceding stage of the cold rolling device.

### (Supplementary Note 11)

Processing equipment for a metal plate, the processing equipment including:
a wiping device that blows a gas to a metal plate to which a molten metal is attached;
an alloying heating device that alloys, by heating, the molten metal attached to the metal plate; and
the induction heating device for a metal plate described in any one of supplementary notes 1 to 8, the induction heating device being disposed between the wiping device and the alloying heating device.

### (Supplementary Note 12)

An induction heating method of a metal plate, the induction heating method including:
a step of passing an AC current to a primary closed circuit formed by a first conductor member that faces at least one of a front surface or a back surface of the metal plate and that is disposed across the metal plate in a width direction, a second conductor member that faces at least one of the front surface or the back surface of the metal plate, that is separated from the first conductor member by a first distance in a plate passing direction of the metal plate, and that is disposed across the metal plate in the width direction, and connecting members that connect the first conductor member and the second conductor member to each other; and
in the metal plate, a step of induction-heating width-directional end portions of the metal plate by allowing a secondary closed circuit formed by induced currents generated in regions respectively facing the first conductor member and the second conductor member to pass through the width-directional end portions of the metal plate.

### (Supplementary Note 13)

An induction heating device for a metal strip, the induction heating device including:
a first conductor member that faces a front surface or a back surface of the metal strip and is disposed across the metal strip in a width direction;
a second conductor member that is positioned to be separated from the first conductor member by a first distance in a plate passing direction of the metal strip, faces the front surface or the back surface of the metal strip, and is disposed across the metal strip in the width direction;
connecting members that connect the first conductor member and the second conductor member to each other at positions separated from width-directional end portions of the metal strip to form a primary closed circuit; and
an AC power supply connected to the primary closed circuit, wherein
the first distance is larger than a sum of dimensions of the first conductor member and the second conductor member in the plate passing direction of the metal strip.

### (Supplementary Note 14)

The induction heating device for a metal strip described in supplementary note 13, in which
first and second primary closed circuits each formed by the first conductor member, the second conductor member, and the connecting member are disposed adjacent to each other in the plate passing direction of the metal strip, and
the AC power supply passes in-phase AC currents to conductor members adjacent to each other in the plate passing direction of the metal strip in the first and second primary closed circuits.

### (Supplementary Note 15)

The induction heating device for a metal strip described in supplementary note 14, further including a switching circuit switchable between series connection and parallel connection of the first and second primary closed circuits.

### (Supplementary Note 16)

The induction heating device for a metal strip described in any one of supplementary notes 13 to 15, further including a magnetic core disposed on a surface of at least one of the first conductor member or the second conductor member on a side opposite to the metal strip.

### (Supplementary Note 17)

The induction heating device for a metal strip described in any one of supplementary notes 13 to 16, in which the connecting members are disposed on at least one side of the metal strip in the width direction so as not to interfere with the metal strip in the thickness direction of the metal strip.

### (Supplementary Note 18)

The induction heating device for a metal strip described in any one of supplementary notes 13 to 17, in which the connecting members includes a movable part capable of moving at least one of the first conductor member or the second conductor member in the plate passing direction of the metal strip.

### (Supplementary Note 19)

Processing equipment for a metal strip, the processing equipment including:
a pickling device for a metal strip; and
the induction heating device for a metal strip described in any one of supplementary notes 13 to 18, the induction heating device being disposed at a preceding stage of the pickling device.

### (Supplementary Note 20)

Processing equipment for a metal strip, the processing equipment including:
a cold rolling device for a metal strip; and
the induction heating device for a metal strip described in any one of supplementary notes 13 to 18, the induction heating device being disposed at a preceding stage of the cold rolling device.

### (Supplementary Note 21)

An induction heating method of a metal strip, the induction heating method including:
a step of passing an AC current to a primary closed circuit formed by a first conductor member that faces a front surface or a back surface of the metal strip and is disposed across the metal strip in a width direction, a second conductor member that faces the front surface or the back surface of the metal strip, is separated from the first conductor member by a first distance in a plate passing direction of the metal strip, and is disposed across the metal strip in the width direction, and connecting members that connect the first conductor member and the second conductor member to each other at positions separated from width-directional end portions of the metal strip; and
in the metal strip, a step of induction-heating the width-directional end portions of the metal strip by allowing a secondary closed circuit formed by induced currents generated in regions respectively facing the first conductor member and the second conductor member to pass through the width-directional end portions of the metal strip.

According to the above configuration, the entire metal strip in the width direction is heated only while passing under (or above) the conductor members, and a heating range between the conductor members is limited to the width-directional end portions of the metal strip. As a result, the end portions of the metal strip in the width direction can be efficiently heated, and the end cracking of the metal strip can be prevented. Since it is possible to ensure a relatively wide interval between an induction coil and a heated material, it is possible to easily cope with deformation, meandering, and the like of the heated material without additional equipment.

### DESCRIPTION OF REFERENCE NUMERALS

100, 200, 400 Induction heating device
101, 101A, 101B Primary closed circuit
102 Secondary closed circuit
110, 110A, 110B, 120, 120A, 120B Conductor member
131, 131A, 131B, 132, 232A, 232B, 232C, 232D, 431 Connecting member
140, 240 AC power supply
351, 352, 361, 362, 371, 372 Magnetic core
Pickling device 500
Cold rolling device 510
Wiping device 522
Alloying heating device 524
S Metal strip

1. An induction heating device for a metal plate, the induction heating device comprising:
a first conductor member that faces at least one of a front surface or a back surface of the metal plate and that is disposed across the metal plate in a width direction;
a second conductor member that is separated from the first conductor member by a first distance in a plate passing direction of the metal plate, that faces at least one of the front surface or the back surface of the metal plate, and that is disposed across the metal plate in the width direction;
connecting members that connect the first conductor member and the second conductor member to each other at positions separated from width-directional end portions of the metal plate to form a primary closed circuit; and
an AC power supply connected to the primary closed circuit, wherein:
the first distance is larger than a sum of dimensions of the first conductor member and the second conductor member in the plate passing direction of the metal plate.

2. The induction heating device for a metal plate according to claim 1, wherein the first conductor member and the second conductor member are disposed to face a same side surface of the metal plate.

3. The induction heating device for a metal plate according to claim 2, wherein the first conductor member and the second conductor member are disposed at a front surface side and a back surface side of the metal plate, respectively.

4. The induction heating device for a metal plate according to claim 1, wherein:
first and second primary closed circuits each formed by the first conductor member, the second conductor member, and the connecting members are disposed adjacent to each other in the plate passing direction of the metal plate, and
the AC power supply passes in-phase AC currents to conductor members adjacent to each other in the plate passing direction of the metal plate in the first and second primary closed circuits.

5. The induction heating device for a metal plate according to claim 4, further comprising a switching circuit switchable between series connection and parallel connection of the first and second primary closed circuits.

6. The induction heating device for a metal plate according to claim 1, further comprising a magnetic core disposed on a surface of at least one conductor member of the first conductor member or the second conductor member, on a side opposite to the metal plate.

7. The induction heating device for a metal plate according to claim 1, wherein the connecting members are disposed on at least one side of the metal plate in the width direction so as not to interfere with the metal plate in a thickness direction of the metal plate.

8. The induction heating device for a metal plate according to claim 1, wherein the connecting members includes a movable part capable of moving at least one conductor member of the first conductor member or the second conductor member in the plate passing direction of the metal plate.

9. Processing equipment for a metal plate, the processing equipment comprising:
a pickling device for the metal plate; and
the induction heating device for a metal plate according to claim 1, the induction heating device being disposed at a preceding stage of the pickling device.

10. Processing equipment for a metal plate, the processing equipment comprising:
a cold rolling device for the metal plate; and
the induction heating device for a metal plate according to claim 1, the induction heating device being disposed at a preceding stage of the cold rolling device.

11. Processing equipment for a metal plate, the processing equipment comprising:
a wiping device that blows a gas to a metal plate to which a molten metal is attached;
an alloying heating device that alloys, by heating, the molten metal attached to the metal plate; and
the induction heating device for a metal plate according to claim 1, the induction heating device being disposed between the wiping device and the alloying heating device.

12. An induction heating method of a metal plate, the induction heating method comprising: a step of passing an AC current to a primary closed circuit formed by a first conductor member that faces at least one of a front surface or a back surface of the metal plate and that is disposed across the metal plate in a width direction, a second conductor member that faces at least one of the front surface or the back surface of the metal plate, that is separated from the first conductor member by a first distance in a plate passing direction of the metal plate, and that is disposed across the metal plate in the width direction, and connecting members that connect the first conductor member and the second conductor member to each other at positions separated from width-directional end portions of the metal plate; and in the metal plate, a step of induction-heating the width-directional end portions of the metal plate by allowing a secondary closed circuit formed by induced currents generated in regions respectively facing the first conductor member and the second conductor member to pass through the width-directional end portions of the metal plate.
